(19) United States
(12) Patent Application Publication
(10) Pub. No.: US 2025/0077470 A1
(43) Pub. Date: Mar. 6, 2025

(54) MEMORY CONTROL SYSTEM AND DISPLAY DEVICE INCLUDING MEMORY CONTROL FUNCTION

(71) Applicant: LX SEMICON CO., LTD., Daejeon (KR)

(72) Inventor: Young Seok LEE, Daejeon (KR)

(73) Assignee: LX SEMICON CO., LTD., Daejeon (KR)

(21) Appl. No.: 18/724,031

(22) PCT Filed: Dec. 23, 2022
(86) PCT No.: PCT/KR2022/021152

§ 371 Date: Jun. 25, 2024

(30) Foreign Application Priority Data
Dec. 30, 2021 (KR) 10-2021-0192079
Dec. 22, 2022 (KR) 10-2022-0182263

(51) Int. Cl. G06F 15/82; G06F 1/14

(52) U.S. Cl. CPC G06F 15/82; G06F 1/14

(57) ABSTRACT

The present invention pertains to a system for managing a reaction time of a memory, and provides a memory control system for managing a deadline for a command in real time and a display device including a memory control function. The memory control system comprises: master processors that each transmit a command and deadline information for the command; and a slave processor that receives the commands, sets a schedule as the deadline information, selects a command in an order from a fast deadline according to the schedule, and performs a process for the selected command, wherein each of the master processors provides the deadline information in which the deadline for the command is changed in response to a change in a transmission time of transmitting the command to the slave processor, and the slave processor reconfigures the schedule in response to a change in the deadline information.

### TECHNICAL FIELD

The present disclosure relates to a system for managing the reaction time of a memory, and more particularly to a memory control system capable of efficiently managing the response time to commands and a display device having a memory control function.

### BACKGROUND ART

Commands generated in a system operating memory need to be appropriately processed within a limited time.

For example, in a system that utilizes a memory, a master processor that provides commands for accessing the memory may be configured to assign a priority to a command when generating the command, and a slave processor that receives the command may be configured to process the command in accordance with the priority.

For example, a display system for processing display data for displaying a screen may include a display device utilizing a memory. In the case of the display device, the time to wait for a command to be executed after the command is generated may vary, and therefore, the urgency with which the command is processed may be changed.

In a memory system such as a display device, when a change in urgency with which the command is processed is not resolved, it is difficult to ensure the stability of operations.

Therefore, to ensure the stability of operations, the memory system requires a sufficient margin to ensure the time between the issuance of a command and the execution of the command. As a result, the memory system suffers from inefficient utilization of slave resources due to the temporal margin reserved for operations.

### DISCLOSURE OF INVENTION

### Technical Problem

An object of the present disclosure is to provide a memory control system capable of securing stability of operations and improving utilization efficiency of slave resources by managing deadlines for processing commands by reflecting a change in a transmission time for which a command of a master processor is transmitted to a slave resource.

Another object of the present disclosure is to provide a display device having a memory control function capable of securing stability of operations and improving utilization efficiency of a memory by managing deadlines for processing commands by reflecting a change in a transmission time for which a command of a data processor is transmitted to a memory controller.

### Technical Solution

According to the present disclosure, a memory control system includes master processors each configured to transmit a command and deadline information for the command; and a slave processor configured to receive commands, set a schedule according to the deadline information, select a command in order of earliest deadline according to the schedule, and perform a process for the selected command, and each of the master processors may provide the deadline information in which a deadline for the command is changed in response to a change in a transmission time for which the command is transmitted to the slave processor, and the slave processor may reconfigure the schedule in response to a change in the deadline information.

According to the present disclosure, a display device having a memory control function includes data processors each configured to perform data processing for display and transmit a command for the data processing and deadline information for the command: a memory controller configured to receive commands, set a schedule according to the deadline information, select a command in order of earliest deadline according to the schedule, and provide the selected command; and a memory configured to store data for the data processing and perform a function corresponding to the command provided from the memory controller for the data, and each of the data processors may provide the deadline information in which a deadline for the command is changed in response to a change in a transmission time for which the command is transmitted to the memory controller, and the memory controller may reconfigure the schedule in response to a change in the deadline information.

### Advantageous Effects

According to the present disclosure, it is possible to generate deadline information by reflecting a change in the transmission time for which a command is transmitted from a master processor to a slave resource, and efficiently manage the reaction time of the slave resource in response to the command in real time using the deadline information.

Accordingly, the stability of the operation corresponding to the command of the memory control system may be secured, and the utilization efficiency of slave resource may be improved.

Further, according to the present disclosure, it is possible to generate deadline information by reflecting a change in the transmission time for which a command is transmitted from a data processor for display to a memory controller, and efficiently manage the reaction time of the memory controller in response to the command in real time using the deadline information.

Accordingly, the stability of the operation corresponding to the command of the display device may be secured, and the utilization efficiency of the memory controller may be improved.

### BRIEF DESCRIPTION OF DRAWINGS

FIG. 1 is a block diagram of a memory control system configured according to an embodiment of the present disclosure.

FIG. 2 is a detailed block diagram illustrating a deadline provider included in a master processor of FIG. 1.

FIG. 3 is a block diagram of a display device configured according to another embodiment of the present disclosure.

FIGS. 4 and 5 are diagrams illustrating control of deadline information in real time.

### BEST MODE FOR CARRYING OUT THE INVENTION

Embodiments of the present disclosure may be implemented with a system including a combination of components on a single chip, which may be separated into masters and slaves.

For example, a memory control system operating a memory may include a plurality of master processors at the master level, which provide commands and a slave processor at the slave level, which receives commands via channels and processes the commands.

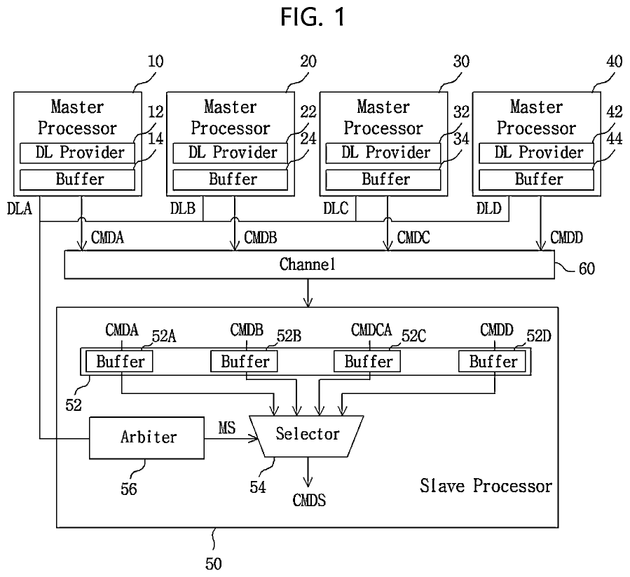

In other words, as shown in FIG. 1, the memory control system may include master processors 10, 20, 30, and 40 and a slave processor 50.

The master processors 10, 20, 30, and 40 may be understood as applications with different functionalities that are intended for different purposes. For example, in the case of a display system, the master processors 10, 20, 30, and 40 may be understood as data processors for independently performing different functions, such as a function of processing sensing data to compensate for pixel deterioration or a function of processing display data to compensate for mura in a display panel.

Further, it may be understood that the slave processor 50 may receive commands from the master processors 10, 20, 30, 40 and perform processes corresponding to the commands. For example, in the case of a display system, the master processors 10, 20, 30, and 40 may understthat the slave processor 50 corresponds to a memory controller that processes commands from to read data from or write data to a memory (not shown).

The master processors 10, 20, 30, and 40 may be configured to communicate with the slave processor 50 via a channel 60. In this case, the channel 60 may be understood to be a shared bus, one-to-one interconnected transmission line and/or the like. A protocol for communication between the master processors 10, 20, 30, and 40 and the slave processors 50 may be configured in a variety of ways, depending on the intent of an operator.

Each of the master processors 10, 20, 30, and 40 may include a deadline provider and a buffer. More specifically, the master processor 10 may include a deadline provider 12 and a buffer 14, the master processor 20 may include a deadline provider 22 and a buffer 24, the master processor 30 may include a deadline provider 32 and a buffer 34, and the master processor 40 may include a deadline provider 42 and a buffer 44.

The slave processor 50 may include a buffer circuit 52, a selector 54, and an arbiter 56. The buffer circuit 52 may include storage areas respectively corresponding to the master processors 10, 20, 30, and 40. The storage areas may refer to internal memory areas, and for ease of understanding, the storage areas may be represented by buffers 52A, 52B, 52C, and 52D. The buffer circuit 52 may be configured to include a plurality of buffers 52A, 52B, 52C, and 52D, according to the intent of the operator.

The commands provided by the master processors 10, 20, 30, 40 may be defined as CMDA, CMDB, CMDC, and CMDD, and the commands CMDA, CMDB, CMDC, and CMDD may be referred to collectively as CMD. Further, deadline information provided by the master processors 10, 20, 30, and 40 may be defined as DLA, DLB, DLC, and DLD, and the deadline information DLA, DLB, DLC, and DLD may be referred to collectively as DL.

The master processors 10, 20, 30, and 40 may provide command CMDs to the slave processors 50 via the channel 60. The master processors 10, 20, 30, and 40 may also provide the deadline information DL to the slave processor 50 via a separate dedicated line. A method of providing the command CMD and the deadline information DL may be implemented in a variety of ways, depending on the intent of the operator, and therefore, a detailed description thereof is omitted.

The master processors 10, 20, 30, and 40 may be understood to have a common structure for providing commands and deadline information, and the configuration and operation of the master processor 10 is described in detail as an example, and the configuration and operation of the remaining master processors 20, 30, and 40 may be understood with reference to the master processor 10.

The master processors 10, 20, 30, and 40 are for transmitting a command CMD and deadline information DL for the command CMD, respectively.

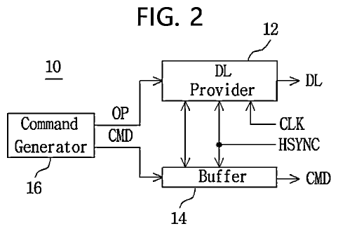

Referring to FIG. 2, the master processor 10 may include a command generator 16, a buffer 14, and a deadline provider 12.

The command generator 16 may generate a command CMD by an internal process and priority information OPs for the command CMD.

For example, the command CMD may be generated when reading data or writing data from or to a memory while performing an internal process, and the command may be transmitted to the slave processor 50 via the buffer 14.

The buffer 14 may be configured to buffer the command CMD provided by the command generator 16 and to transmit the command CMD to the slave processor 50. To this end, the buffer 14 may be understood to be in connected with the channel 60.

In the case of a display system, a screen may be formed by one frame of data, the one frame may include a plurality of horizontal lines, and each of the horizontal lines may be formed by one horizontal period of data. In this case, the data per frame may be separated by a vertical synchronization signal, and the data per horizontal line may be separated by a horizontal synchronization signal HSYNC.

When the embodiment of the present disclosure is applied to a display system, the buffer 14 may buffer data in the units of horizontal lines, and for this purpose, the buffer 14 may be configured such that the input and output of data is controlled by the horizontal synchronization signal HSYNC. In other words, the buffer 14 may be configured to use the horizontal synchronization signal HSYNC as a synchronization signal for buffering commands.

The command generator 16 may generate a priority information OP for the command CMD in consideration of a type or urgency of the command when generating the command CMD. The priority information OP may include a code or value capable of identifying the type or urgency of a command, and may include a code or value for coupling with the command. In other words, the priority information OP may be generated to be matched with the command CMD.

The priority information OPs from the command generator 16 may be provided to the deadline provider 12.

The deadline providing part 12 may be configured to receive the priority information OP and output deadline information DL corresponding to the priority information OP.

The deadline provider 12 may generate the state information of the buffer 14 by referring to a synchronization signal for driving the buffer 14, that is, the horizontal synchronization signal HSYNC. In other words, the deadline provider 12 may check the information of the buffer 14 in real time, and may generate the amount of change in the transmission time of the command CMD with the state of the buffer 14 checked in real time.

The deadline provider 12 may use a clock signal CLK with a shorter period than that of the horizontal synchronization signal HSYNC to check the information of the buffer 14 in real time. The deadline provider 12 may generate the amount of change in the transmission time of the command CMD of the buffer 14 several times during one period of the horizontal synchronization signal HSYNC, by using the clock signal CLK. The deadline provider 12 may periodically generate the amount of change in the transmission time of the command CMD by using the clock signal CLK.

The deadline provider 12 may generate a weight reflecting the amount of change in the transmission time, and may generate the deadline information DL by combining the weight with the priority information OP and output the deadline information DL generated as described above.

In other words, when the master processor 10 generates the command CMD, the master processor 10 may generate priority information OP for the command CMD, and the deadline provider 12 may generate deadline information DL by combining the weight corresponding to the transmission time of the command CMD of the buffer 12 with the priority information OP on a current basis.

After the master processor 10 has transmitted the command CMD and the deadline information DL, the deadline provider 12 may generate the amount of change in the transmission time of the command CMD of the buffer 12, change the deadline information DL by combining the weight reflecting the amount in change of the transmission time with the priority information OP, and provide the changed deadline information DL to the slave processor 50.

In this case, it may be exemplified that the amount of change in the transmission time of the command CMD of the buffer 12 is generated as a change in the amount of data in the buffer 12 that is periodically checked by the clock signal CLK.

In other words, the master processor 10 may periodically generate the amount of change in the transmission time of the command CMD, periodically change the deadline information DL, and periodically provide the changed deadline information DL to the slave processor 50. The period may be defined using the clock signal CLK.

As described above, the master processors 10, 20, 30, and 40 may provide the command CMD and the deadline information DL to the slave processor 50 over the channel 60, and the deadline information DL may be provided to the slave processor 50 periodically.

The slave processor 50 may be configured to receive the command CMDs, set a schedule based on the deadline information, select the command CMD in order of earliest deadline according to the schedule, and perform a process for the selected command CMD.

Further, the slave processor 50 may be configured to reconfigure the schedule in response to changes in the deadline information, select the command CMD in order of earliest deadline according to the reconfigured schedule, and perform a process for the selected command CMD.

The slave processor 50 may stack the command CMDs transmitted over the channel 60 in a buffer circuit 52.

In the slave processor 50, the arbiter 56 may be configured to receive the deadline information DL, set a schedule with the deadline information DL, and provide a selection signal MS for selecting the command CMD in order of earliest deadline according to the schedule.

In the slave processor 50, a selector 54 may be configured to select and output a command CMD corresponding to the selection signal MS from among the command CMDs stacked in the buffer circuit 52. The commands CMDs input to the selector 54 may include commands CMDA, CMDB, CMDC, and CMDD provided by the master processors 10, 20, 30, and 40, and the command output from the selector 54 may be defined as CMDS.

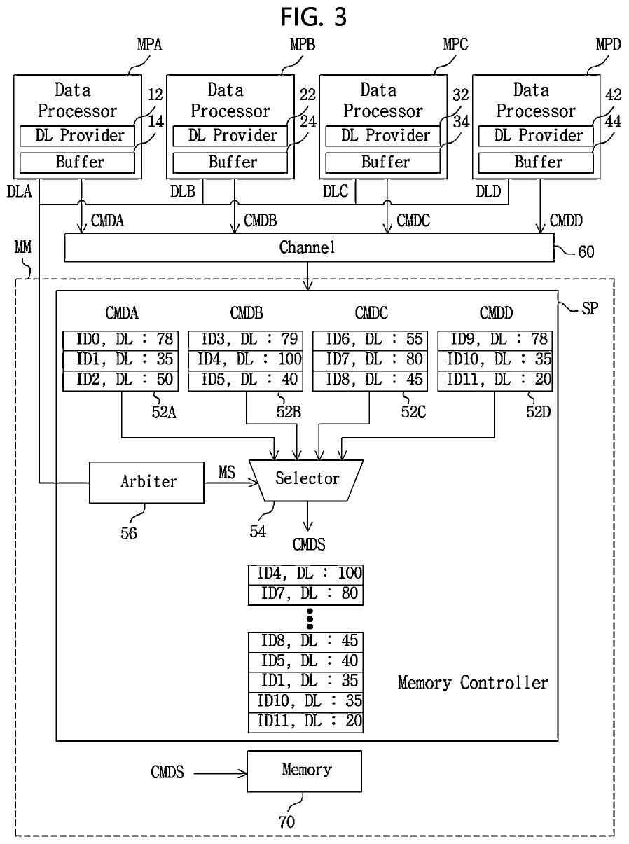

More specific operations of the master processors 10, 20, 30, and 40 and the slave processor 50 may be described with reference to FIG. 3.

It may be understood that FIG. 3 illustrates a display device having memory control functionality as an embodiment of the present disclosure.

In FIG. 3, data processors MPA, MPB, MPC, and MPD are configured as master processors 10, 20, 30, and 40, and a memory controller SP is configured as the slave processor 50.

The data processors MPA, MPB, MPC, and MPD may perform data processing for display and may be configured to provide commands CMDA, CMDB, CMDC, and CMDD and deadline information DLA, DLB, DLC, and DLD to the memory controller SP over the channel 60.

The memory controller SP may function as a slave processor. In other words, the memory controller SP may be configured to receive commands CMDA, CMDB, CMDC, and CMDD, set a schedule with the deadline information DLA, DLB, DLC, and DLD, select a command in order of earliest deadline according to the schedule and provide the selected command CMDS.

The display device of FIG. 3 may include a memory 70, and the memory 70 may store data for data processing and perform a function corresponding to the command CMDS provided from the memory controller SP on the data. That is, the memory 70 may read data or write data in response to the command CMDS.

In FIG. 3, the memory controller SP and the memory 70 may be understood as one memory module MM, and the memory controller SP may be understood as having a function of controlling command access to the memory 60.

Each of the data processors MPA, MPB, MPC, and MPD in FIG. 3 may provide deadline information DL with a changed deadline for the command CMD in response to a change in the transmission time for which the command CMD is transmitted to the memory controller SP. In addition, the memory controller SP may reconfigure a schedule in response to a change in the deadline information DL.

As an example, the data processor MPA may sequentially provide ID0, ID1, and ID2 as the command CMDA, and the memory controller SP may stack ID0, ID1, and ID2 in the buffer 52A. Here, ID0 may be understood as an identification code or identification value to identify the command CMDA. Additionally, the data processor MPA may provide deadline information DL of “78” corresponding to a change in the transmission time for which the command CMDA at the time of providing ID0 is transmitted to the memory controller SP. The deadline information DL described above may be provided to the arbiter 56.

The data processors MPB, MPC, and MPD may also sequentially provide ID3 to ID11 as the commands CMDB, CMDC, and CMDD, and the memory controller SP may stack the corresponding commands in the corresponding buffers 52B, 52C, and 52D, respectively. Further, the deadline information DL for each command may be generated to have a value corresponding to a change in the transmission time for which the command CMD at the time of providing ID3 to ID11 is transmitted to the memory controller SP and may be provided to the arbiter 56.

The arbiter 56 may sort the transmitted deadline information DL in order of urgency and provide a selection signal MS for selecting a command CMDS to the selector 54 according to the sorted order.

The selector 54 may select a command CMDS corresponding to the selection signal MS among the commands CMD of the buffers 52A, 52B, 52C, and 52D, and output the corresponding command CMDS.

The memory controller SP may perform a process corresponding to the command CMDS selected by the selector 54, and the process may include providing the command CMDS to the memory 70.

Each of the data processors MPA, MPB, MPC, and MPD may operate according to a different horizontal synchronization signals HSYNC. Therefore, the deadlines required for the data processors MPA, MPB, MPC and MPD may be different.

The command CMD generated by each data processor MPA, MPB, MPC or MPD may be finally transferred to the memory controller SP, which is a destination, through an internal buffer. The time for the command CMD to be transferred to the memory controller SP may be difficult to predict.

The memory controller SP, which is the destination, may receive commands CMD from several data processors MPA, MPB, MPC and MPD and process the received commands CMD. When the deadlines for the commands CMD are not set, the order in which the commands CMD are to be processed may change depending on the internal state of the memory controller SP.

In order to solve this problem, the present disclosure is implemented such that the data processors MPA, MPB, MPC, and MPD, which are master processors provide deadline information for commands CMD.

The memory controller SP may identify the set deadlines and process the commands CMD in the order in which the deadline is urgent, resulting in stable processing of the commands.

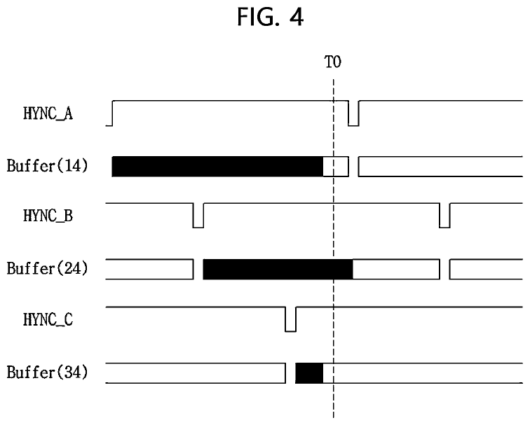

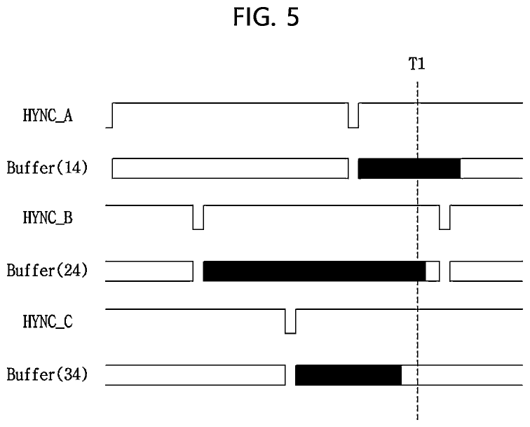

As an example, a method for setting deadline information DL will be described with reference to FIGS. 4 and 5. According to an embodiment of the present disclosure, the deadline information DL may have a deadline adjusted based on the horizontal synchronization signal HSYNC.

In FIGS. 4 and 5, HSYNC_A is a horizontal synchronization signal of the data processor MPA, HSYNC_B is a horizontal synchronization signal of the data processor MPB, and HSYNC_C is a horizontal synchronization signal of the data processor MPC. FIGS. 4 and 5 illustrate a state in which the buffers 14, 24, and 34 of the data processors MPA, MPB, and MPC are filled with data.

FIG. 4 is for checking a buffer state at time TO, and FIG. 5 is for checking a buffer state at time T1.

Referring to FIG. 4, the buffer 14 may correspond to a case where the capacity is insufficient compared to the horizontal synchronization signal HSYNC at time T0, the buffer 24 may correspond to a case where the capacity is sufficient compared to the horizontal synchronization signal HSYNC at time TO, and the buffer 34 may correspond to a case where the capacity is insufficient compared to the horizontal synchronization signal HSYNC at time T0, but the remaining horizontal time is sufficient.

Among the above cases, in the case of the buffer 14, the highest weight of priority may be assigned, in the case of the buffer 24, the lowest weight of priority may be assigned, and in the case of the buffer 34, the weight of priority may be assigned at a medium level.

The deadline providers 12, 22, and 32 of the data processors MPA, MPB, and MPC may generate deadline information DLA, DLB, and DLC, respectively by combining the weights determined with reference to FIG. 4 with the priority information OP.

Referring to FIG. 5, the buffer 14 may correspond to a case where the capacity is sufficient compared to the horizontal synchronization signal HSYNC at time T1, the buffer 24 may correspond to a case where the capacity is sufficient compared to the horizontal synchronization signal HSYNC at time T1 but the remaining horizontal time is short, and the buffer 34 may correspond to a case where the capacity is insufficient compared to the horizontal synchronization signal HSYNC at time T1, but the remaining horizontal time is sufficient.

Among the above cases, in the case of the buffer 14, the lowest weight of priority may be assigned, in the case of the buffer 24, the highest weight of priority may be assigned, and in the case of the buffer 34, the weight of priority may be assigned at a medium level.

The deadline providers 12, 22, and 32 of the data processors MPA, MPB, and MPC may generate deadline information DLA, DLB, and DLC, respectively by combining the weights determined with reference to FIG. 5 with the priority information OP.

As shown in FIGS. 4 and 5, the urgency of the command CMD may change over time.

Therefore, in an embodiment of the present disclosure, the master processor may periodically determine a weight according to the urgency of the command CMD according to a change in the transmission time for which the command CMD is transmitted to the slave processor, and periodically update deadline information DL in which the weight is reflected in the priority for the command transmitted to the slave processor.

Therefore, the slave processor may periodically reconfigure a schedule using the deadline information DL that reflects weights that change in real time, and execute a process of selecting a command CMDS according to the reconfigured schedule and transmitting the selected command CMDS to a memory.

Therefore, a system or device with a memory control function may ensure the stability of operations corresponding to commands.

Additionally, the deadline information is updated in real time, thus reducing the margin for stable operation of slave resources. Therefore, the utilization efficiency of slave resources may be improved.

1-15. (canceled)

16. A memory control system comprising:
master processors each configured to transmit a command and deadline information for the command; and
a slave processor configured to receive commands, set a schedule according to the deadline information, select a command in order of earliest deadline according to the schedule, and perform a process for the selected command,
wherein each of the master processors is configured to provide the deadline information in which a deadline for the command is changed in response to a change in a transmission time for which the command is transmitted to the slave processor, and
wherein the slave processor is configured to reconfigure the schedule in response to a change in the deadline information.

17. The memory control system of claim 16, wherein each of the master processors is configured to generate priority information for the command when the command is generated, and generate the deadline information by combining a weight corresponding to the transmission time on a current basis with the priority information.

18. The memory control system of claim 17, wherein each of the master processors is configured to generate an amount of change in the transmission time after transmitting the command and the deadline information, change the deadline information by combining the weight reflecting the change in the transmission time with the priority information, and provide the changed deadline information to the slave processor.

19. The memory control system of claim 18, wherein each of the master processors is configured to periodically generate the amount of change in the transmission time, periodically change the deadline information, and periodically provide the changed deadline information to the slave processor.

20. The memory control system of claim 19, wherein the slave processor is configured to periodically reconfigure the schedule in response to receipt of the changed deadline information.

21. The memory control system of claim 19, wherein each of the master processors includes:
a command generator configured to generate the command and the priority information for the command;
a buffer configured to buffer the command and transmit the command to the slave processor; and
a deadline provider configured to generate the amount of change in the transmission time with state information of the buffer referring to a synchronization signal for driving the buffer, receive the priority information, and output the deadline information generated by combining the weight reflecting the amount of change in the transmission time with the priority information.

22. The memory control system of claim 21, wherein the command generator is configured to generate the command when data is read from a memory or data is written to the memory.

23. The memory control system of claim 21, wherein the buffer is configured to buffer data in units of horizontal lines.

24. The memory control system of claim 21, wherein the buffer is configured to use a horizontal synchronization signal as a synchronization signal for buffering the command.

25. The memory control system of claim 21, wherein the deadline provider is configured to receive a clock signal with a shorter period than the synchronization signal, periodically generate the amount of change in the transmission time using the clock signal, periodically change the deadline information, and periodically provide the deadline information to the slave processor.

26. The memory control system of claim 21, wherein the slave processor includes:
a buffer circuit configured to stack the commands of the master processors;
an arbiter configured to receive the deadline information, set the schedule with the deadline information, and provide a selection signal for selecting the command in order of earliest deadline according to the schedule; and
a selector configured to select and output the command corresponding to the selection signal among the commands stacked in the buffer circuit.

27. A display device having a memory control function, the display device comprising:
data processors each configured to perform data processing for display and transmit a command for the data processing and deadline information for the command;
a memory controller configured to receive commands, set a schedule according to the deadline information, select a command in order of earliest deadline according to the schedule, and provide the selected command; and
a memory configured to store data for the data processing and perform a function corresponding to the command provided from the memory controller for the data,
wherein each of the data processors is configured to provide the deadline information in which a deadline for the command is changed in response to a change in a transmission time for which the command is transmitted to the memory controller, and
wherein the memory controller is configured to reconfigure the schedule in response to a change in the deadline information.

28. The display device of claim 27, wherein each of the data processors is configured to generate the command when access to the memory is required for the data processing, and generate predetermined priority information according to importance of the command for the data processing.

29. The display device of claim 27, wherein each of the data processors is configured to generate the deadline information by combining a weight corresponding to the transmission time on a current basis with priority information predetermined corresponding to the command.

30. The display device of claim 29, wherein each of the data processors is configured to generate an amount of change in the transmission time in real time, change the deadline information by combining the weight reflecting the change in the transmission time with the priority information, and provide the changed deadline information to the memory controller in real time.

31. The display device of claim 30, wherein each of the data processors is configured to periodically generate the change in the transmission time by referring to a clock signal with a shorter period than a horizontal synchronization signal used for display, and periodically provide the deadline information, which is changed in response to generation of the amount of change in the transmission time, to the memory controller.

32. The display device of claim 27, wherein each of the data processors includes:
a command generator configured to generate the command and the priority information for the command;
a buffer configured to buffer the command and transmit the command to the micro controller; and
a deadline provider configured to generate the amount of change in the transmission time with state information of the buffer referring to a horizontal synchronization signal for driving the buffer, receive the priority information, and output the deadline information generated by combining the weight reflecting the amount of change in the transmission time with the priority information.

33. The display device of claim 32, wherein the command generator is configured to generate the command when data is read from the memory or data is written to the memory.

34. The display device of claim 32, wherein the buffer is configured to buffer data in units of horizontal lines.

35. The display device of claim 32, wherein the micro controller includes:
a buffer circuit configured to stack the commands of the data processors;
an arbiter configured to receive the deadline information, set the schedule with the deadline information, and provide a selection signal for selecting the command in order of earliest deadline according to the schedule; and
a selector configured to select and output the command corresponding to the selection signal among the commands stacked in the buffer circuit.
